(19) United States
(12) Patent Application Publication
(10) Pub. No.: US 2019/0279169 A1
(43) Pub. Date: Sep. 12, 2019

(54) A Communication Device For Managing Refuse Collection Performed According To Pre-Established Schedule, A Process For Managing Refuse Collection And A System For Managing Refuse Collection

(71) Applicant: ECO MOBILE d.o.o., Zagreb (HR)

(72) Inventor: Aleksandar Ivanovic, Zagreb (HR)

(21) Appl. No.: 16/304,913

(22) PCT Filed: May 27, 2016
(86) PCT No.: PCT/EP2016/025051

§ 371 Date: Nov. 27, 2018

(51) Int. Cl. G06Q 10/00; G06F 16/27; G06F 16/25; G06Q 10/10; H04L 29/12

(52) U.S. Cl. CPC G06Q 10/30; G06F 16/27; H04W 4/80; G06Q 10/1097; H04L 61/6022; G06F 16/252

(57) ABSTRACT

A system and communication devices for managing refuse collection. The communication devices include a master device for receiving a download list and displaying the same, a plurality of slave devices attached to refuse containers, each having a MAC address. The download list comprises list of MAC addresses of the plurality of slave devices located in the communication range of the master device. The master device scans for slave devices. If a scanned MAC address of a slave device is listed on the download list, the master device sends command to the slave device to emit a signal, preferably a flashing green LED light, signalling that the refuse container needs to be emptied.

### FIELD OF THE INVENTION

This invention generally relates to managing and improving city services, and more particularly to managing and allocating resources using a communication devices and network to more efficiently utilize the resources and promote efficiency of the refuse collection. Present invention relates to a communication devices provided with visual signalization for managing refuse collection according to a pre-established schedule, a process for managing refuse collection and to a system for managing refuse collection,

### BACKGROUND OF THE INVENTION

A common practice for emptying the containers of their contents is to employ a service vehicle which includes a hopper for receiving the contents of the containers, and a lifting mechanism for engaging each of the several containers and for lifting the engaged container to the hopper. In the course of lifting the container to the hopper, steps are taken to invert the container so that its contents fall into the hopper under the influence of gravity. This is often facilitated by providing the lifting mechanism and the container with cooperating structures which enable the operator to perform the desired operations remotely, from the service vehicle.

To improve overall efficiency, U.S. patent application Ser. No. 09/965,964, filed Sep. 28, 2001 (now U.S. Pat. No. 6,448,898 issued Sep. 10, 2002), and entitled “System for Auditing Refuse Collection” describes a system for auditing the refuse collection process. To this end, customers are charged for service according to the number of times their refuse containers are accessed. The customers subscribing to the service are in this way motivated to call for collections of their refuse only from containers that are substantially full, or the refuse collection service is compensated for additional container pick-ups.

Such collections can be called for using a device such as is described in U.S. Pat. No. 6,295,946, issued Oct. 2, 2001, and entitled “Signalling Device for Use with a Container”. The disclosed signalling device preferably takes the form of a flag, one end of which is coupled with a hinge associated with the refuse container. The hinged connection allows the flag to move between a lowered position in which the flag lies over the cover of the container, and a raised position in which the flag extends upwardly from the container, developing a change in state which is indicative of access to the container. The signalling device is automatically returned to the lowered position when the container is emptied.

The above-described systems work well to provide an efficient refuse collection operation, or to implement other operations that can benefit from such improvements. However, in accordance with the present invention, an alternative system has been developed which can still further enhance the efficiency of the overall operations being performed.

The present invention relates primarily to the field of refuse collection, and more particularly, to a system which can operate to manage the number of times their refuse containers are accessed and emptied, and to communicate to a central facility as refuse container is emptied by a refuse collection service. Although the following discussion is given in the context of refuse collection, it will be appreciated that the following improvements can benefit other industries which use containers for any of a variety of diverse purposes.

### SUMMARY OF THE INVENTION

In conjunction with the collection of refuse, common practice is to station containers at each of a plurality of sites so that customers of the collection service can deposit refuse in their respective containers for subsequent collection, usually according to a pre-established schedule. The collection service then takes appropriate steps, according to the pre-established schedule, to empty the containers of its customers and to remove the contents for disposal. Some collection services charge a flat fee for the services provided, while others charge according to the number of containers that are emptied.

The general purpose of the present invention, which will be described subsequently in greater detail, is to provide a communicating devices and a system for managing refuse collection according to the pre-established schedule to empty the containers of its customers, wherein schedule is based on the number of emptying of the particular container according to the customer's demand. This tended to limit the overall efficiency of the operation, in turn contributing to unnecessary costs.

It is an object of the present invention is to provide a communication devices for managing refuse collection in which a master device, wearable by person performing a refuse collection or coupled to the service vehicle, is provided with means for receiving a download list over internet connection and displaying the same, the master device is further provided with a Bluetooth low energy module capable communicating with a plurality of slave devices where each slave device is attached to the particular refuse container. Each slave device is provided with a high brightness signalling LED light, a 3-axis linear accelerometer, a microcontroller, a Bluetooth low energy module and independent power supply.

The master database is maintained at central facility operated by city service responsible for refuse collection and management.

The master database may include comparator means for comparing data sourced from each remote unit with data stored on the master database for generating a download list.

A further object of the present invention is to provide a process for managing refuse collection according to pre-established schedule. The process includes downloading and displaying the download list on the master device, wherein the download list contains list of media access control addresses (MAC addresses) of the plurality of slave devices at selected locations, which slave devices are affixed to the refuse containers scheduled for emptying, where said refuse containers and respectively slave devices are located in the communication range of the master device.

The process includes the prior step of entering the data in the master database at a facility centre, wherein the data comprise pre-established schedule of emptying for each of the refuse containers of its customers and communicating the retrieved data in the form of the signal from the master device to the plurality of slave devices on selected location, wherein each of the slave devices according to the received signal emits intermitting light of particular colour defining if particular refuse container is scheduled for emptying or not.

Still an additional object of the present invention is to provide a system for managing refuse collection according to the pre-established schedule.

### BRIEF DESCRIPTION OF THE DRAWINGS

For further detail regarding preferred implementations of the present invention, reference is made to the detailed description which is provided below, taken in conjunction with the following illustrations:

FIG. 1 is a schematic view of a system which has been provided with pre-established schedule for emptying containers of its customers in accordance with the present invention;

FIG. 2 is a perspective view of an embodiment of a master device in accordance with the present invention;

FIG. 3 is a perspective view of an embodiment of a slave device in accordance with the present invention;

FIG. 4 is a partial perspective view illustrating an embodiment of a slave device attached to the refuse container in accordance with the present invention;

FIG. 5 is a block diagram illustrating configuration of a master device in accordance with the present invention;

FIG. 6 is a block diagram illustrating configuration of a slave device in accordance with the present invention;

FIG. 7 is a flow diagram illustrating process of operation of a master device in accordance with the present invention; and

FIG. 8 is a flow diagram illustrating process of operation of a slave device in accordance with the present invention.

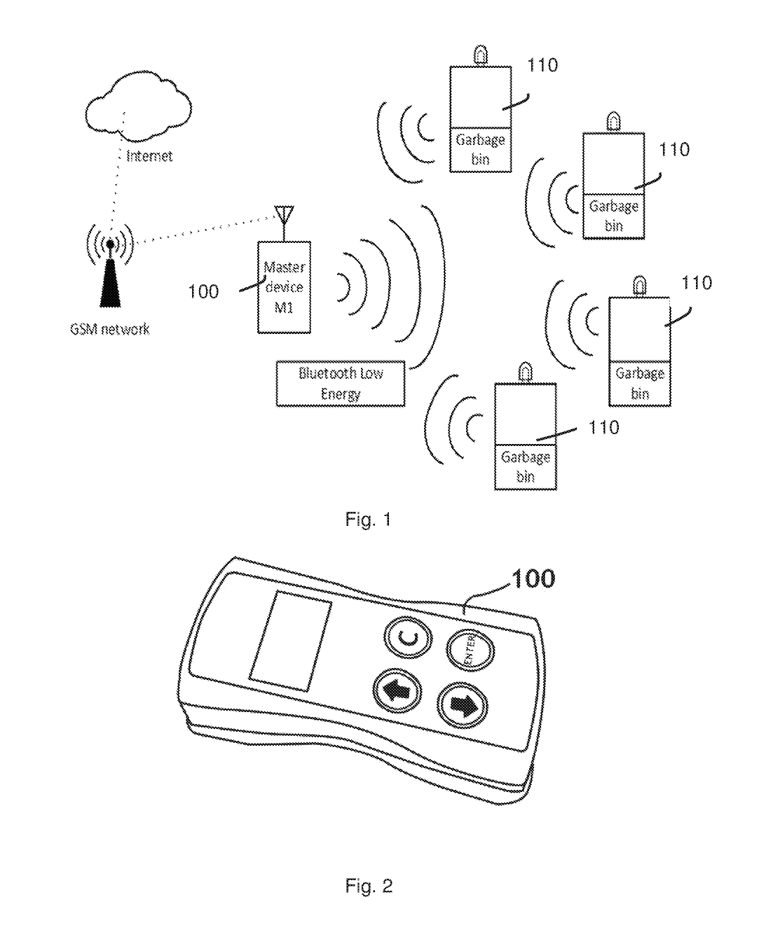

### DETAILED DESCRIPTION OF THE INVENTION

A system for managing refuse collection performed by a refuse collection service for emptying a refuse containers 120 according to pre-established schedule, the system consisting of:

a communication network provided for the refuse collection service, the refuse collection service managing a master database which can be accessed via a modem on the Internet, wherein the master database includes customers data and the schedule of emptying customers containers,

a communication devices consisting of a plurality of slave devices 110 where particular slave device 110 is affixed to the particular refuse container 120, and a master device 100, wearable by person performing a refuse collection or coupled to the service vehicle, the master device 100 capable receiving a download list over Internet connection and displaying the same, wherein the master device 100 is establishing Bluetooth connection with the plurality of slave devices 110 located in the communication range of the master device 100,

wherein the download list comprises list of MAC addresses of the plurality of slave devices 110 located in the communication range of the master device 100.

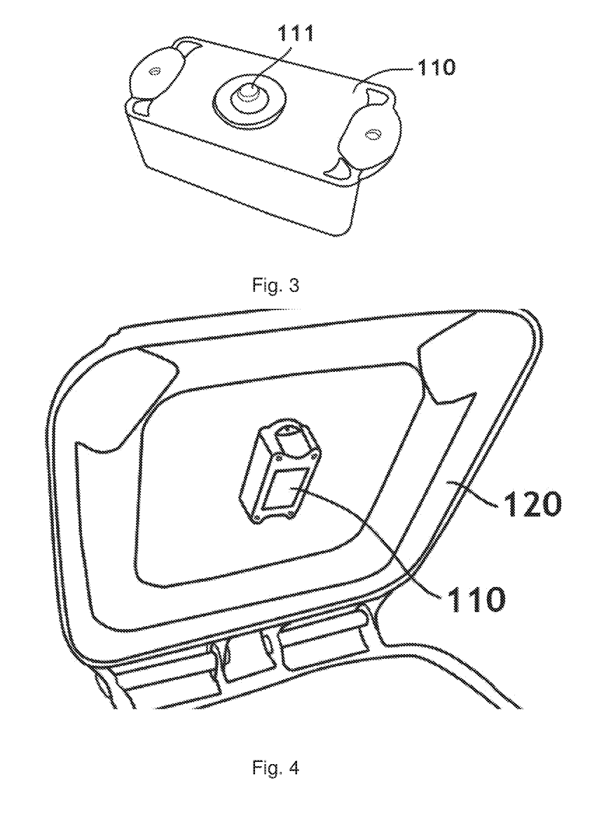

The system is typically used to manage the emptying of a plurality of refuse containers 120, particularly to the containers which located in particular area, wherein operation of emptying is performed according to pre-established schedule. Referring to the drawings, in accordance with the invention, the system includes a communication devices comprising a plurality of slave devices 110 which are provided at refuse containers, the refuse containers 120 are emptied according to the pre-established schedule (see FIGS. 3 and 4), and a master device 100, (see FIG. 2) wearable by person performing a refuse collection or the master device 100 is coupled to the service vehicle, a communication network and a facility centre which includes a master database (MDB). As described in more detail below, the system manages refuse collection, and its progress according to pre-established schedule of emptying plurality of refuse containers 120. The system includes a facility centre with its master database which can be accessed via a modem on the Internet. Each master device 100 of the system also includes means for connecting to the Internet. The master device 100 further includes a communication means, such as Bluetooth low energy module, for communicating with the plurality of slave devices 110 at selected locations, where each slave device is affixed to different refuse container 120, and further to each of the slave devices 110 is assigned MAC address.

FIG. 4 shows the refuse container 120 to which has been affixed the slave device 110 produced in accordance with the present invention. It will be understood that the container 120 shown in FIG. 4 is a schematic representation of any of a variety of different types of containers that can be used for containing refuse which is to be collected by a servicing agency. It is also to be understood that a refuse container has been selected only for purposes of illustration, and that the improvements of the present invention can similarly be used with any of a variety of different types of containers, which can be used for purposes other than refuse collection. Although the description which follows discusses the application of the improvements of the present invention to refuse containers, and refuse collection operations, it is further to be understood that the improvements of the present invention can be used with other types of systems for containing articles, and for servicing such containers or their contents.

The slave unit 110 typically includes a unique identifier, e.g. a unique identification code, uniquely to identify the refuse container 120 within which it is mounted. The unique identification code is presented in the master database as MAC address.

The communication network may include GPS (Global Positioning System) and/or a communication network e.g. GMS (Global System for Mobile Communications).

The system may include an identification interface for identifying an operator or user involved in the system. A schedule for emptying of the plurality of containers 120 may be downloaded from the master database and fed into the remote master device 100. Typically, the master database includes customer data and the schedule of emptying customer's container. The master database is maintained at central facility operated by city service responsible for refuse collection and management. The stored data can then be used to establish routing, and dispatch the appropriate personnel and equipment.

The master database comprises data relating to each container and pre-established schedule of each container emptying, the schedule is defined according to the customers demand. The schedule for emptying of the plurality of containers 120 at selected location is in the form of a download list which is displayed on a LCD screen of the master device 100. When the download list is communicated between the master device 100 and the master database, the master device 100 is ready for operation and activates the plurality of slave devices 110 located in the communication range of the master device 100, so that each slave device 110 receives command to start emitting an intermitting light.

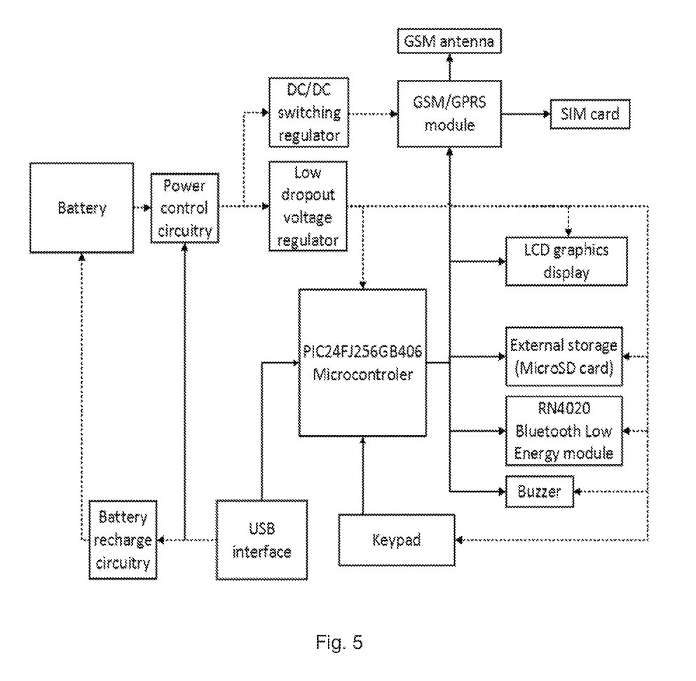

The plurality of slave devices are provided with visual signalization for improved and easier managing refuse collection, wherein communication devices comprise master device 100, wearable by person performing a refuse collection or the master device 100 is coupled to the service vehicle, and a plurality of slave devices 110, wherein each slave device 110 is attached to the particular refuse container 120. The master device 100 is hooked to the belt of an employee, or in some other way, while an employee is performing emptying of the plurality of refuse containers 120. The master device 100 (see FIGS. 2 and 5) is provided with a GSM/IGPRS module, a SIM card, a GSM antenna, a LCD graphic display, a keypad, a microcontroller, a Bluetooth low energy module and a battery with a recharge and a power control circuitry. Further, the master device 100 is provided with an external storage card, a buzzer, voltage regulator and a DC/DC switching regulator. The master device 100 is operated via the keypad and has a built-in LCD graphic display to select a function and display downloaded list. The first step is to choose the menu via the keypad to download the list of the containers 120 scheduled to be emptied. For downloading the list is not required any special application since the download list is retrieved via the Internet in JSON format (JavaScript Object Notation). The download list of the containers 120 scheduled for emptying can be exported by any data processing programs such as Excel, SQL, MySQL, PostgreSQL or the like. The master device 100 will download the data list using TCIP protocol via the Internet from the default IP address and port. The download list consists of a list of media access control addresses (MAC addresses) of the slave devices 110 located in particular area within the range of the master device 100 Bluetooth low energy module, wherein the download list includes only the MAC addresses of the slave devices 110 affixed to the refuse containers 120 that are scheduled for emptying, After downloading the list, the master device 100 will display the information that the data list is successfully downloaded, which means that the master device 100 is ready for operation. The master device 100, when said device is switched on, has a constantly running Bluetooth module and activates each of the plurality of slave devices 110 that are located in the communication range of the master device 100. After the master device 100 has successfully downloaded list, its GSM device is disabled and Bluetooth module of the master device 100 is enabled in order to scan Bluetooth modules of the plurality of slave devices 110 that are situated at selected location. Afterwards the master device 100 connects to the plurality of slave devices 110 and determines if each of the MAC addresses of the slave devices 110 is present on the download list or not, For the MAC addresses assigned to the slave devices 110 is present on the download list, the master device 100 sends to those slave devices 110 command to emit intermitting green light, Green light provides a visual indication to the operator that refuse container 120 with affixed slave device 110 emitting green light is scheduled for emptying. When the operator performs emptying of the particular refuse container 120 with affixed the slave device 110 emitting green light, the MAC address of the said slave device 110 will be removed from the download list, Each of the slave devices 110 is provided with the 3-axis linear accelerometer indicating change in their position. Depending on the type of the refuse container 120 and manner of its emptying, the slave device 110 needs to be affixed to the refuse container 120 on such a position that after emptying the refuse container, the 3-axis linear accelerometer indicates container's emptying and sends information to the master device 100, thereafter the MAC address of the emptied refuse container 120 is removed from the list. Further, for the MAC addresses assigned to the slave devices 110 not present on the download list, meaning that said slave devices 110 i.e. the slave devices 110 affixed to the refuse containers 120 that are not scheduled for emptying, the master device 100 sends to those slave devices 110 command to emit intermitting red light. Red light provides a visual indication to the operator that refuse container 120 with affixed slave device 110 emitting red light is not scheduled for emptying. When finally operator performs emptying of all the refuse containers 120 from the download list, the Bluetooth module of the master device 100 is disabled, and the operator can proceed to a subsequent location.

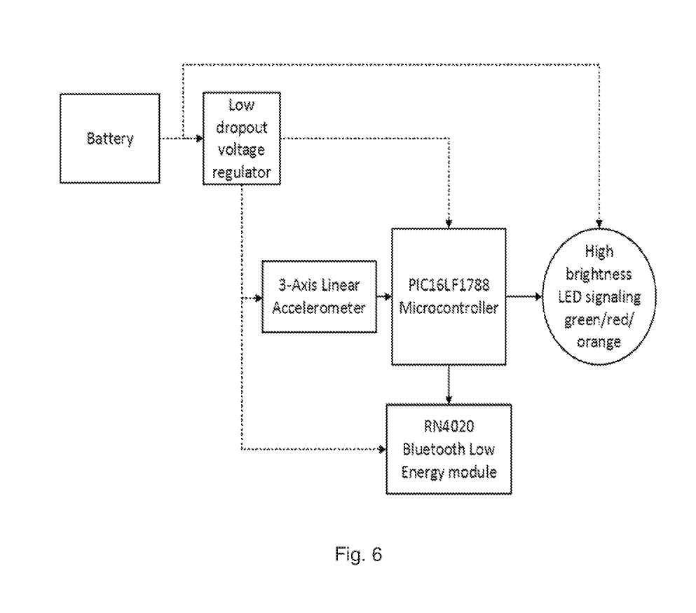

Each of the slave devices 110 (see FIGS. 3, 4 and 6) is provided with a high brightness signalling LED light, a 3-axis linear accelerometer, a microcontroller, a Bluetooth low energy module and independent power supply, wherein each slave device 110 has unique MAC address assigned to particular refuse container 120, the container 120 assigned to particular customer, or the group of customers. Data relating the refuse containers 120 and its customers are saved and frequently updated in the master database maintained by customer facility. The refuse container 120 may include the slave device 110, or the slave device 110 may be mounted at the time of the manufacture of the refuse container 120. Instead it may be retrofitted to an existing refuse container 120. The slave device 110 is attached to the outside visible part of the container 120, or at the underside of the lid of the container 120. The slave device includes a power source, the power source may be in the form of a rechargeable battery. In this regard, the battery may be rechargeable from an electrical mains supply. Instead, the battery may be rechargeable via a battery charger arrangement. The battery charger arrangement may include a solar panel. The slave device 110 is dismountably mounted in the refuse container 120 permitting its removal and mounting in a different refuse container 120. The slave device 110 includes a unique identifier in the form of the MAC address, uniquely to identify the refuse container 120 within which it is mounted. Communication between each slave device 110 and remote master device 100 is typically done in a wireless fashion, such as Bluetooth low energy wireless technology. After the master device 100 activates the plurality of slave devices 110, the high brightness signalling LED light 111 starts emitting intermitting light. When an employee wearing the master device 100 approaches in the vicinity of the refuse containers 120, where each of the containers 120 has affixed the slave device 110, the master device 100 will send to each of the slave devices 110 a command to activate the LED light 111. LED light 111 is designed to emit intermitted light signal (e.g. duration of the blink may be 0.5 seconds and the duration of how long it repeats the blinks e.g. 60 seconds). Depending on the fact whether the MAC address of the particular slave device 110 is on the download list, or respectively is not present on the download list, the command sent by the master device 100 to each slave device 110 contains information on the colour to be emitted by the LED light 111. If the refuse container 120 is scheduled for emptying, the attached slave device 110 emits intermitting green light. If the refuse container 120 is not scheduled for emptying, the attached slave device 110 emits intermitting red light. Convention in relation to said colours can define other colours as long as differentiating colours in respect of visual signalling are provided, thus signalling which of the refuse containers 120 are scheduled for emptying and which of refuse containers 120 are not scheduled for emptying. Upon successfully downloading the download list and the master device 100 is operating, the plurality of slave devices 110 in the communication range of the master device 100 start emitting intermitting light of the particular colour visually indicating whether particular refuse container is scheduled for emptying or not. This way the efficiency of the overall refuse collection is being performed, and service based on charging for service according to the number of times customer's refuse containers are emptied is enhanced. Further, each of the slave devices 110 is provided with the 3-axis linear accelerometer indicating change in their position. Depending on the type of the refuse container 120 and the manner of its emptying, the slave device 110 needs to be affixed to the refuse container 120 on such a position that after emptying the refuse container, the 3-axis linear accelerometer indicates container's emptying and sends information to the master device 100, thereafter the MAC address of the emptied refuse container 120 is removed from the download list.

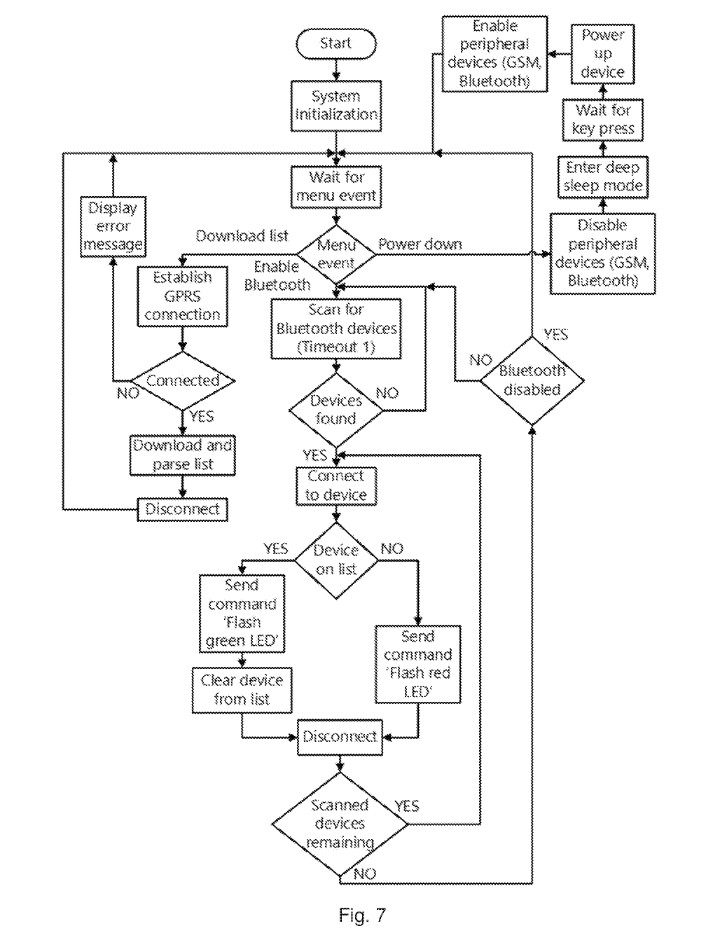

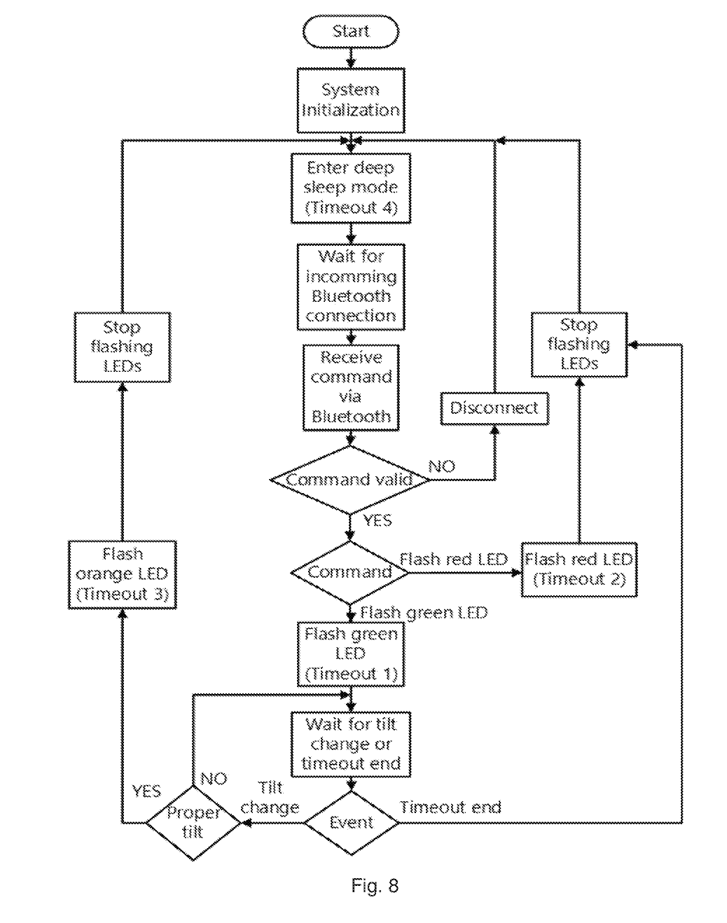

FIGS. 7 and 8 illustrate flow diagram illustrating process of operation of the master device 100 and the slave device 110 in a process for managing refuse collection.

A process for managing refuse collection performed by a refuse collection service from a refuse containers 120 according to pre-established schedule, wherein each of the refuse containers 120 include affixed a communication slave device 110, and each of the plurality of slave devices 110 at selected location is communicating with a master device 100, wherein the process comprises the steps of:
switching on the master device 100 and enabling its GSM device and Bluetooth low energy module, and thereafter connecting the master device 100 via Internet with a refuse collection service maintaining a master database;
initialization of the master device 100 and waiting for menu event and establishing a GPRS connection;
downloading and displaying a download list on the master device 100 LCD display, wherein the download list contains the list of MAC addresses of the plurality of slave devices 110 affixed to the refuse containers 120, the refuse containers 120 are scheduled for emptying, where said refuse containers 120 with affixed slave devices 110 are located in the communication range of the master device 100;
scanning for Bluetooth modules of the plurality of slave devices 110 affixed to the containers 120;
determining if the slave devices 110 are found; and
establishing a connection between the master device 100 and the each found of the plurality of the slave devices 110.

Thereafter establishing the connection, the master device 100 compares MAC addresses from the download list with the MAC addresses of the connected slave devices 110 and determines which MAC addresses of the slave devices 110 is present on the downloaded list.

If MAC address of the particular slave device 110 is present on the download list, the master device 100 sends command to the slave device 110 to emit intermitting green LED light, the green LED light is signalling that refuse container needs to be emptied.

After the refuse container 120 is being moved in a manner that it is emptied, a 3-axis linear accelerometer provided in the slave device 110 indicates that refuse container 120 is emptied, and thereafter sends the information of to the master device 100, wherein the MAC address of the said emptied refuse container 120 is removed from the download list.

If the MAC address of the particular slave device 110 is not on the download list, the master device 100 sends command to the slave device 110 to emit intermitting red LED light, the red LED light signalling that container 120 is not scheduled for emptying.

Time of intermitting LED light of the slave device 110 is preferably in the range from 60 to 120 seconds, but another time interval can be set.

The master device 100 sends the commands to the plurality of slave devices 110 until all MAC addresses of the slave devices 110 present on the download list are removed from said download list, and thereafter the intermitting lights are disconnected.

After downloading and displaying the download list of MAC addresses of the refuse containers 120 scheduled for emptying GSM device and Bluetooth low energy module of the master device 100 are disabled.

As previously indicated, the communicating devices of the present invention can be used with any of a variety of different types of containers (including refuse containers and containers for use in applications other than the handling of refuse).

The customer data in the master database can be processed to produce customer billing which reflects a given subscriber's use of the refuse collection service (e.g., according to the number of times the subscriber's container has been emptied, the weight of the contents removed, or a combination of these parameters). The subscriber's billing can in this way reflect the actual cost of the services performed.

It will be understood that various changes in the details, materials and arrangement of parts which have been herein described and illustrated in order to explain the nature of this invention may be made by those skilled in the art within the principle and scope of the invention as expressed in the following claims.

1.-24. (canceled)

25. A system for managing refuse collection performed by a refuse collection service from a refuse containers according to pre-established schedule of each refuse container emptying, the system having communication devices comprising:
a master device capable of receiving a download list and displaying the same;
a plurality of slave devices, each slave device being attached to a refuse container, wherein:
the master device has a wireless communications module for activating each of the plurality of slave devices that are located within the communication range of the master device,
each of the slave devices has a signalling LED light, a microcontroller, a wireless communications module and an independent power supply, wherein each of the slave devices has unique MAC address;
wherein the download list specifies MAC addresses of the slave devices attached to refuse containers that are scheduled for emptying, whereby the master device activates the LED lights of the slave devices having MAC addresses specified in the download list to emit light of a selected color, wherein the color indicates that the refuse container is scheduled for emptying.

26. The system according to claim 25, wherein the master device is provided with a 3-axis linear accelerometer for detecting refuse container emptying movement, a GSM/GPRS module, a GSM antenna, a LCD graphic display, a keypad, a microcontroller, a Bluetooth low energy module and a battery with a recharge and power control circuitry.

27. The system according to claim 25, wherein the download list is downloaded from a server maintained by the refuse collection service via the Internet by using TCIP protocol.

28. The system according to claim 27, wherein the server contains a master database containing a data relating to each MAC address of the slave devices affixed to the refuse containers and a schedule for emptying of each refuse container.

29. The system according to claim 25, wherein independent power supply of each slave device is a rechargeable battery from an electrical means supply or a battery charger arrangement including a solar panel.

30. The system according to claim 25, wherein the slave device is affixed to the outside visible part of the refuse container, or at the underside of the lid of the refuse container.

31. The system according to claim 25, wherein the refuse containers are of any type, including containers for use in applications other than the handling of refuse.

32. A process for managing refuse collection from refuse containers according to a pre-established schedule using communication devices comprising: a master device capable of receiving a download list and displaying the same; a plurality of slave devices, each slave device being attached to a refuse container, wherein: the master device has a Bluetooth low energy module for activating each of the plurality of slave devices that are located within the communication range of the master device and a GSM/GPRS module, a GSM antenna, a LCD graphic display, a keypad, a microcontroller, and a battery with a recharge and power control circuitry; and wherein each of the slave devices has a signalling LED light, a microcontroller, a Bluetooth low energy module for receiving an activation signal from the master device and an independent power supply, wherein each of the slave devices has unique MAC address; wherein the download list specifies MAC addresses of the slave devices attached to refuse containers that are scheduled for emptying, whereby the master device activates the LED lights of the slave devices having MAC addresses specified in the download list , wherein the process comprises the steps of:
activating the master device and enabling its GSM device and wireless communication module, and thereafter connecting the master device via Internet with a master database;
downloading and displaying a download list from the master database on the master device LCD display, wherein the download list specifies MAC addresses of the plurality of slave devices affixed to the refuse containers that are scheduled for emptying, where said refuse containers with affixed slave devices are located in the communication range of the master device;
scanning for Bluetooth modules of the plurality of slave devices affixed to the containers;
determining if a MAC address of a scanned Bluetooth module of a slave devices matches a MAC address specified in the download list;
establishing a connection between the master device and any slave device having a MAC address specified in the download list, and
activating the LED light of the slave device having a MAC address specified in the download list to emit light of a selected color, the colored LED light visually indicating whether particular refuse container is scheduled for emptying or not.

33. The process according to claim 32, wherein thereafter establishing the connection, the master device compares MAC addresses from the download list with the MAC addresses of the connected slave devices and determines which MAC addresses of the slave devices is present on the downloaded list.

34. The process according to claim 32, wherein a 3-axis linear accelerometer provided in the slave device to detect and indicate that refuse container has been emptied, and wherein the slave device sends a signal to the master device indicating that the refuse container associated with the slave device has been emptied, wherein the MAC address of the said emptied refuse container is removed from the download list.

35. The process according to claim 34, wherein the LED light of the slave device is an intermittently flashing light activated every 60 to 120 seconds.

36. The process according to claim 32, wherein the master device sends the commands to the plurality of slave devices until all MAC addresses of the slave devices present on the download list are removed from said download list, and thereafter the LED lights of each slave device are deactivated.
